(19) United States
(12) Patent Application Publication
(10) Pub. No.: US 2010/0161398 A1
(43) Pub. Date: Jun. 24, 2010

(54) WEB-BASED ADVERTISING REWARD SYSTEM

(75) Inventors: Lorenzo Toldra ALBERT, Valencia (ES); Artur Sales COSTA, Valencia (ES)

Correspondence Address: MERCHANT & GOULD PC, P.O. BOX 2903, MINNEAPOLIS, MN, 55402-0903, US

(73) Assignee: ADAGREED S.L., Valencia, ES (unknown)

(21) Appl. No.: 12/340,859

(22) Filed: Dec. 22, 2008

(51) Int. Cl. G06Q 30/00; G06F 17/30

(52) U.S. Cl. 705/14.11; 705/10; 705/27; 705/14.59; 705/14.66; 705/14.19

(57) ABSTRACT

A system for rewarding online viewing of advertisements is described. The system comprises a processor and a memory comprising a set of executable instructions which, when executed by the processor, cause the processor to receive a user profile comprising demographic user information; to receive an advertising campaign comprising at least one advertisement, at least one reward amount identifier, and at least one user selection criteria; to transmit at least one advertisement to a user based on a comparison of the at least one user selection criteria and the user profile; and receive a user vote based on the at least one advertisement.

### BACKGROUND

Existing network based advertising systems known to the inventors, supply text and/or audio or video advertisements to users for the possibility that a user may interact with the advertisement, e.g., click or select the advertisement and follow the link such as a hyperlink network resource location to the site of a company supplying the advertisement. Often, users do not view an advertisement in its entirety and infrequently interact with the advertisements.

### DESCRIPTION OF THE DRAWINGS

One or more embodiments are illustrated by way of example, and not by limitation, in the figures of the accompanying drawings, wherein elements having the same reference numeral designations represent like elements throughout and wherein:

FIG. 1 is a high-level block diagram of a network usable in conjunction with an embodiment;

FIG. 2 is a high-level functional block diagram of a content generation computer system according to an embodiment;

FIG. 3 is a high-level functional block diagram of a content delivery computer system according to an embodiment;

FIG. 4 is a high-level functional block diagram of a user computer system according to an embodiment;

FIG. 5 is a high-level process flow diagram of at least a portion of a method according to an embodiment;

FIG. 6 is a high-level functional block diagram of at least a data storage portion of a content delivery system according to an embodiment;

FIG. 7 is a high-level functional process flow diagram of at least a user interaction portion of a content delivery system according to an embodiment;

FIG. 8 is a high-level functional process flow diagram of at least an advertisement transfer portion of a content delivery system according to an embodiment; and

FIG. 9 is a high-level functional process flow diagram of at least an advertiser interaction portion of a content delivery system according to an embodiment.

### DETAILED DESCRIPTION

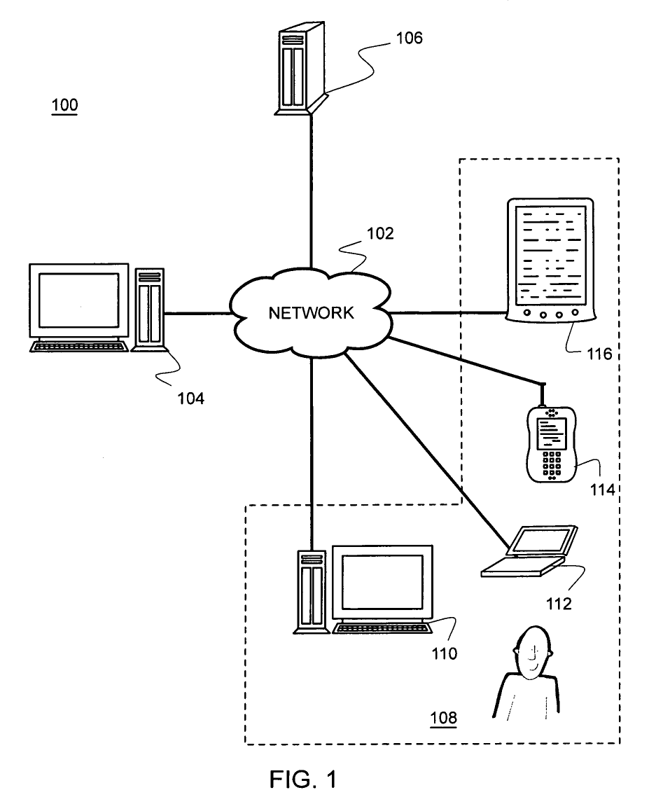

FIG. 1 depicts a high-level block diagram of a networked system 100 in connection with which an embodiment of the present invention may be used to great advantage. Networked system 100 comprises at least three components interconnected by a network 102: a content generation system 104; a content delivery system 106; and a user 108.

Content generation system 104 comprises a computer system of an advertiser desiring to have advertisements viewed by user 108. In at least some embodiments, the advertiser may be an advertising company, a media advertising agency, a company, an individual, or another entity generating advertising content to be viewed by user 108. Hereinafter content generation system 104 may alternatively be referred to as advertiser 104.

Advertiser 104 is cooperatively coupled to content delivery system 106 and/or user 108 via a connection to network 102 which may comprise wired and/or wireless connections. In at least some embodiments, advertiser 104 generates advertising content and supplies the generated content to content delivery system 106 for delivery to user 108.

Content delivery system 106 comprises a computer system of a network-based advertising reward system. In at least some embodiments, the network-based advertising rewards system is a World Wide Web (WWW)-based system. In at least some embodiments, content delivery system 106 comprises a Web server for receiving content generated by advertiser 104 and supplying the received content to user 108.

Content delivery system 106 is cooperatively coupled to content generation system 104 and the user 108 via a connection to network 102 which may comprise wired and were wireless connections. Hereinafter, content delivery system 106 may alternatively be referred to as delivery system 106.

User 108 comprises a user and one or more network-connected devices such as a desktop computer system 110, a laptop or portable computer system 112, a cellular or other voice-based communication device 114, or a personal digital assistant 116. User 108 comprises at least one device configured to display content received from content delivery system 106, e.g., a computing device as described above, a television or monitor-connected computing device, or other video console system, e.g., a video game system such as a Playstation system available from Sony Corporation or an Xbox system available from Microsoft Corporation. In at least some embodiments, user 108 comprises a network interface for connecting with delivery system 106. In at least some embodiments, the connection between user 108 and delivery system 106 may comprise a constant connection and/or an intermittent connection.

For simplicity and ease of reference, desktop computer system 110 (also referred to as user computer system or user system) may be used to refer to each of the one or more network-connected device. User 108 may be used to refer to the users use of and/or interaction with or manipulation of at least one of network-connected devices 110, 112, 114, 116.

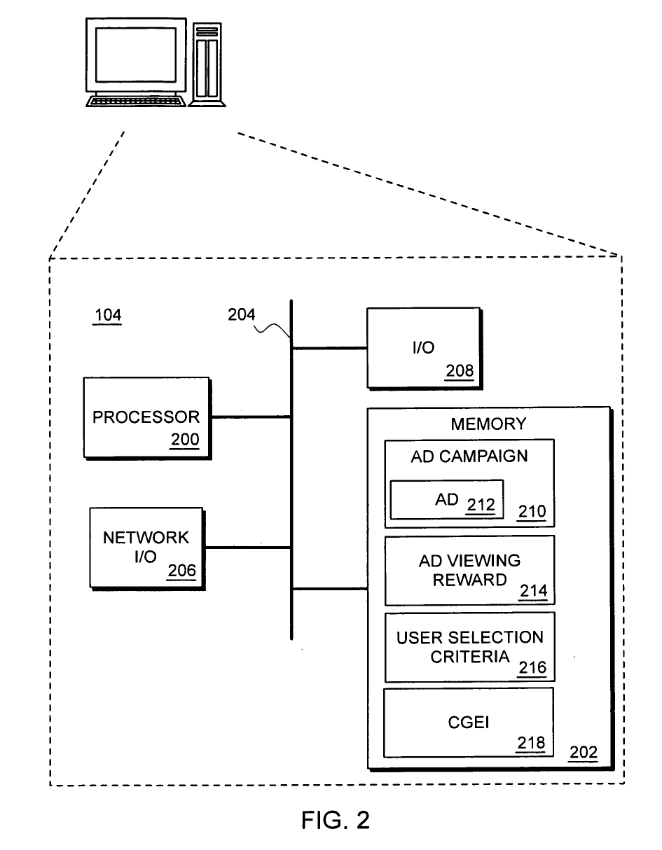

FIG. 2 depicts a high-level functional block diagram of content generation computer system 104 usable in conjunction with one or more embodiments. Content generation computer system 104 comprises a processor 200 (alternatively referred to as a processing device), a memory 202, a network interface (I/F) 206, and an input/output (I/O) device 208 communicatively coupled via a bus 204 or other interconnection communication mechanism.

In at least some embodiments, processor 200 may be a controller or an application specific integrated circuit (ASIC) configured to provide the functionality described herein with respect to content generation computer system 104.

Memory 202 (also referred to as a computer-readable medium) may comprise a random access memory (RAM) or other dynamic storage device, coupled to the bus 204 for storing data and/or instructions to be executed by processor 200. Memory 202 also may be used for storing temporary variables or other intermediate information during execution of instructions to be executed by processor 200. Memory 202 may also comprise a read only memory (ROM) or other static storage device coupled to the bus 204 for storing static information and instructions for the processor 200.

Memory 202 stores at least one advertising campaign 210 which in turn comprises one or more advertisements 212, at least one ad viewing reward 214, and at least one user selection criteria 216. Ad viewing reward 214 and user selection criteria 216 are each related to an ad campaign 210. In at least some embodiments, each ad 212 of an ad campaign 210 may be related to one or more ad viewing reward 214 and user selection criteria 216.

Memory 202 may store one or more ad campaigns 210, one or more advertisements 212, one or more ad viewing rewards 214, and one or more user selection criteria 216.

Each ad campaign 210 may comprise one or more advertisements 212. In at least some embodiments, advertisements 212 on an ad campaign 210 may be arranged to be displayed according to one or more methods, e.g., chronologically, sequentially, parallel, geographically, or by other sorting criteria.

Ad viewing reward 214 comprises a specified, predetermined reward value to be assigned to a user 108 subsequent to completion of viewing an advertisement 212. In at least some embodiments, ad viewing reward 214 may specify a predetermined reward value to be assigned to a user 108 subsequent to completion of viewing an ad campaign 210. In at least some further embodiments, ad viewing reward 214 may be assigned to user 108 subsequent to completion of viewing an advertisement 212 and subsequent to the user voting on the viewed advertisement. That is, user 108 only receives ad viewing reward 214 subsequent to both viewing an advertisement 212 and voting on the viewed advertisement.

In at least some embodiments, ad viewing reward 214 comprises a predetermined point value. In at least some other embodiments, ad viewing reward 214 comprises a monetary value. In at least some other embodiments, ad viewing reward 214 comprises a point-based reward to the exclusion of monetary-based rewards. In at least some further embodiments, content delivery system 106 assigns ad viewing reward 214 to the exclusion of content generation system 104, e.g., an advertiser.

User selection criteria 216 comprises a specified, predetermined set of criteria to be applied by content delivery system 106 in order to determine whether to offer display of a particular advertisement 212 and/or advertising campaign 210 to a particular user.

In at least some embodiments, advertiser 104 transmits advertisement 212 along with a corresponding ad viewing reward 214 and a user selection criteria 216 to content delivery system 106.

Memory 202 may also store content generating executable instructions (CGEI) 218 for enabling an advertiser to create advertisements and/or advertising campaigns 210 for delivery by content delivery system 106.

In at least some embodiments, content generation computer system 104 may comprise a storage device in addition to memory 202.

Network I/F 206 comprises a mechanism for connecting to network 102 (FIG. 1). In at least some embodiments, content generation computer system 104 comprises more than a single network interface. In at least some embodiments, network I/F 206 may comprise a wired and/or wireless connection mechanism.

I/O device 208 may comprise an input device, an output device and/or a combined input/output device for enabling user interaction. An input device may comprise, for example, a keyboard, keypad, mouse, trackball, trackpad, and/or cursor direction keys for communicating information and commands to processor 200. An output device may comprise, for example, a display, a printer, a voice synthesizer, etc. for communicating information to a user. In at least some embodiments, I/O device 208 may comprise a serial and/or parallel connection mechanism.

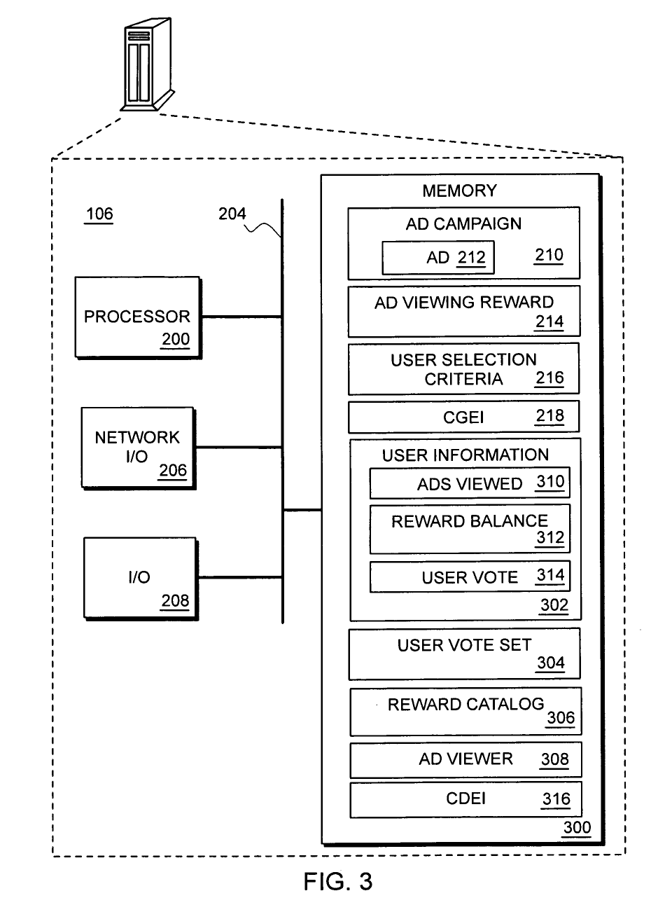

FIG. 3 depicts a high-level functional block diagram of content delivery computer system 106 usable in conjunction with one or more embodiments. Content delivery computer system 106 comprises a processor 200 (similar to processor 200 of FIG. 2), a memory 300, a network I/F 206 (similar to network I/F 206 of FIG. 2), and an I/O device 208 (similar to I/O device 208 of FIG. 2) communicatively coupled via a bus 204 (similar to bus 204 of FIG. 2) or other interconnection communication mechanism.

Memory 300 (also referred to as a computer-readable medium) may comprise a random access memory (RAM) or other dynamic storage device, coupled to the bus 204 for storing data and/or instructions to be executed by processor 200. Memory 300 also may be used for storing temporary variables or other intermediate information during execution of instructions to be executed by processor 200. Memory 300 may also comprise a read only memory (ROM) or other static storage device coupled to the bus 204 for storing static information and instructions for the processor 200.

Memory 300 stores advertisement 212 as part of advertising campaign 210 received from content generation system 104. In at least some embodiments, memory 300 stores advertisement 212 without storing advertising campaign 210. Memory 300 also stores ad viewing reward 32 hundred 14 and user selection criteria 216 perceived from content generation system 104.

In at least some embodiments, memory 300 also stores (CGEI) 218 for download by content delivery system 104.

Memory 300 stores user-related information 302, a user vote set 304, a reward catalog 306, and an ad viewer 308. User-related information 302 comprises information related to each user 108 as supplied by the user. User information 302 (also referred to as a user profile) comprises biographic and demographic information about the user. Further, user information 302 comprises information related to user interaction with content delivery system 106 and/or content delivered by the content delivery system. User interaction information comprises an ads viewed information 310, a reward balance 312, and a user vote 314.

Ads viewed information 310 comprises advertisement identifying information, e.g., ad identifiers, which indicates which ads have been viewed by the particular user. In at least some embodiments, ads viewed information 310 comprises only advertisement identifying information related to the ads which have been completely viewed by the user, i.e., the ads viewed information excludes ads which have only been partially viewed by the user.

Reward balance 312 comprises a running total of rewards received by a user in response to ad viewing. Additionally, reward balance 312 may be reduced by an amount equal to a reward redemption by the user.

User vote 314 comprises information related to a user vote and/or ranking of a particular advertisement viewed by the user. User vote 314 comprises at least an advertisement identifier and the user vote. In at least some embodiments, user vote 314 may comprise a numeric value or an alphanumeric value.

User vote set 304 comprises information related to user votes received from one or more users with respect to one or more particular ads 212 and/or advertising campaigns 210. In at least some embodiments, user vote set 304 may comprise a database for storing user voting information.

Reward catalog 306 comprises information about potential rewards which the user may redeem all or a portion of reward balance 312 in order to receive. For example, reward catalog 306 may comprise information about particular items and how many points are required to be redeemed in order to acquire the item. In at least some embodiments, user 108 is able to redeem reward balance 312 by interaction with content delivery system 106. In at least some further embodiments, user 108 is able to redeem reward balance 312 by interaction solely with content delivery system 106. In at least some further embodiments, user 108 is able to redeem reward balance 312 by interaction with content generation system 104, e.g., advertisers.

Ad viewer 308 comprises a set of executable instructions for download and execution by user computer system 110 in order to enable user 108 to view and vote and/or rank advertisements 212. Ad viewer 308 provides a mechanism for the user to input commands to cause user computer system 110 to receive one or more advertisements 212 from content delivery system 106 and to transmit user vote 314 to content delivery system 106.

Memory 300 also stores a content delivery executable instruction set (CDEI) 316 which, when executed by processor 200, causes the processor to interact with content generation system 104 and user 108 (via user computer system 110). CDEI 316 applies user selection criteria 216 to user information 302 in order to determine whether to transmit a particular advertisement 212 and/or advertising campaign 210 to user 108. Further, CDEI 316 determines which advertisement 212 to transmit to user 108 based on one or more received user votes 314. In at least some embodiments, CDEI 316 selects advertisements to be transmitted to the user based on the prior viewing and voting history of the user.

In at least some embodiments, content delivery computer system 106 may comprise a storage device in addition to memory 300.

Network I/F 206 of FIG. 3 (similar to FIG. 2) comprises a mechanism for connecting to network 102 (FIG. 1). In at least some embodiments, content delivery computer system 106 comprises more than a single network interface. In at least some embodiments, network I/F 206 may comprise a wired and/or wireless connection mechanism.

I/O device 208 of FIG. 3 (similar to FIG. 2) may comprise an input device, an output device and/or a combined input/output device for enabling user interaction. An input device may comprise, for example, a keyboard, keypad, mouse, trackball, trackpad, and/or cursor direction keys for communicating information and commands to processor 200. An output device may comprise, for example, a display, a printer, a voice synthesizer, etc. for communicating information to a user. In at least some embodiments, I/O device 208 may comprise a serial and/or parallel connection mechanism.

In at least some embodiments, content delivery system 106 does not include I/O device 208.

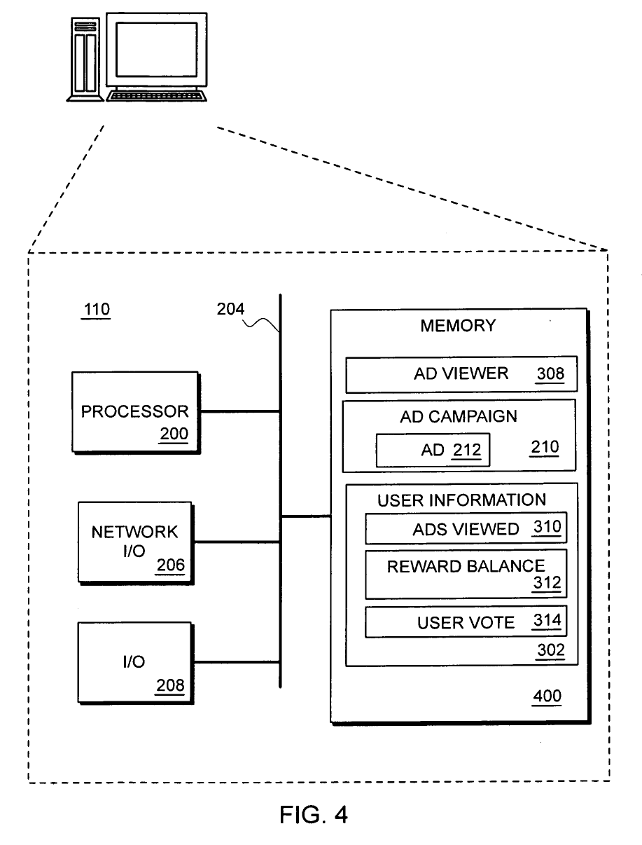

FIG. 4 depicts a high-level functional block diagram of user computer system 110 usable in conjunction with one or more embodiments. User computer system 110 comprises a processor 200 (similar to processor 200 of FIG. 2), a memory 400, a network I/F 206 (similar to network I/F 206 of FIG. 2), and an I/O device 208 (similar to I/O device 208 of FIG. 2) communicatively coupled via a bus 204 or other interconnection communication mechanism.

Memory 400 (also referred to as a computer-readable medium) may comprise a random access memory (RAM) or other dynamic storage device, coupled to the bus 204 for storing data and/or instructions to be executed by processor 200. Memory 400 also may be used for storing temporary variables or other intermediate information during execution of instructions to be executed by processor 200. Memory 400 may also comprise a read only memory (ROM) or other static storage device coupled to the bus 204 for storing static information and instructions for the processor 200.

Memory 400 stores ad viewer 308, ad campaign 210, and user information 302. In at least some embodiments, ad viewer 308 may be a web browser. In at least some embodiments, ad viewer 308 may be a set of components downloaded for installation and execution in conjunction with and/or as a part of a web browser, e.g., plug-ins, scripts, etc.

Ad viewer 308 comprises a set of executable instructions which, when executed by a processor, cause the processor to download an advertisement 212 to the user system 110 and to cause an I/O device, e.g., a display, to display the downloaded ad to user 108. In at least some embodiments, ad viewer 308 responds to user 108 input to cause the exchange of data and information with external applications such as provided by web services using extensible markup language (XML)-based files compliant with common XML schema definitions (XSD). In at least some embodiments, ad viewer 308 uses active server method (ASMX) definitions to link web services providing data to the ad viewer.

Ad viewer 308 displays the downloaded ad 212 to user 108 and enables the user to supply input assigning a rank to the viewed ad. The assigned rank comprises user vote 314 and is transmitted to content delivery system 106. In at least some embodiments, ad viewer 308 stores a downloaded ad 212 in memory 400.

Ad viewer 308, responsive to received user input, enables functionality corresponding to play, skip, stop, rewind, forward, and other functions related to an advertisement 212 displayed to the user. Additionally, ad viewer 308 comprises uniform resource location (URL) identifiers or other mechanisms enabling user 108 to obtain content from an advertiser or other entity related to the ad.

In at least some embodiments, ad viewer 308 may be executed as a screen saver or automatically during a process requiring long duration exceeding a predetermined number of minutes, e.g., copying or downloading files. That is, ad viewer 308 may automatically execute to display ad 212 during copying of a large file or a large number of files. For example, the automatic execution may begin after exceeding a predetermined number of minutes within which no user input is received by ad viewer 308.

In at least some embodiments, ad viewer 308 is configured to allow searching of ads based on matching criteria and text in ad descriptions. In at least some other embodiments, ad viewer 308 is configured to display a visualization of the rank of a user based on reward balance 312 in comparison to other users.

In at least some embodiments, memory 400 does not store ads viewed 310, i.e., after the user has viewed and voted on the ad, user system 110 deletes the ad from memory 400.

In at least some other embodiments, reward balance 312 and user vote 314 are not stored in memory 400 beyond a temporary time period required to transfer the information from user system 110 to content delivery system 106.

In at least some embodiments, user computer system 110 may comprise a storage device in addition to memory 400.

Network I/F 206 of FIG. 4 (similar to FIG. 2) comprises a mechanism for connecting to network 102 (FIG. 1). In at least some embodiments, user computer system 110 comprises more than a single network interface. In at least some embodiments, network I/F 206 may comprise a wired and/or wireless connection mechanism.

I/O device 208 of FIG. 4 (similar to FIG. 2) may comprise an input device, an output device and/or a combined input/output device for enabling user interaction. An input device may comprise, for example, a keyboard, keypad, mouse, trackball, trackpad, and/or cursor direction keys for communicating information and commands to processor 200. An output device may comprise, for example, a display, a printer, a voice synthesizer, etc. for communicating information to a user. In at least some embodiments, I/O device 208 may comprise a serial and/or parallel connection mechanism.

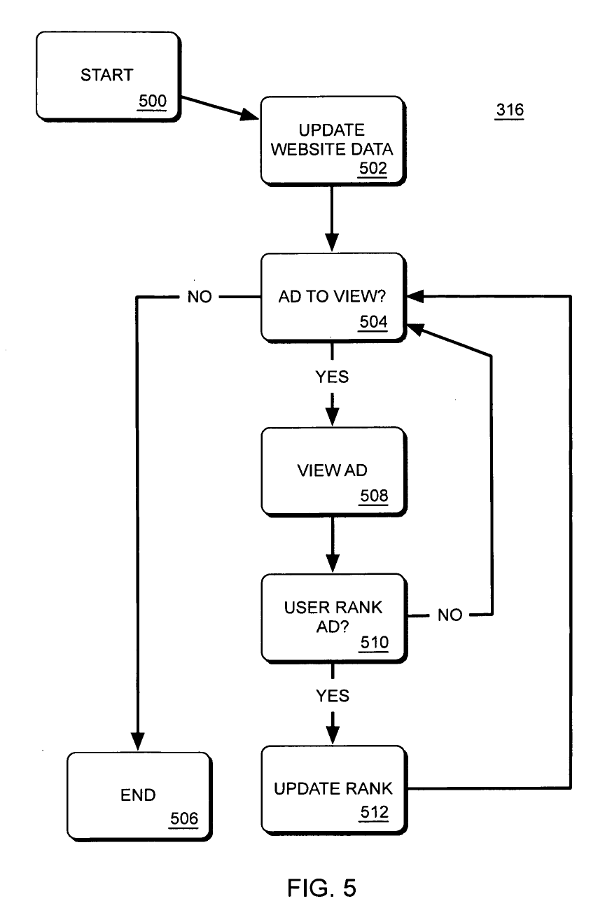

FIG. 5 depicts a high-level functional process flow diagram of at least a portion of CDEI 316 (FIG. 3) when executed by processor 200 of content delivery system 106. The process flow begins at start functionality 500. The flow proceeds to update website data functionality 502 wherein content delivery system 106 updates website data, e.g., ad campaign 210 and one or more ads 212, ad viewing reward 214, and user selection criteria 216 each received from content generation system 104, user information 302 received from user 108, or user vote set 304 and reward catalog 306.

The flow then proceeds to ad query functionality 504 wherein content delivery system 106 determines whether user information 302 matches user selection criteria 216 for ad 212. For example, if user information 302 indicates based on a history of user vote 314 that a user has ranked car advertisements higher than motorcycle advertisements, then content delivery system 106 applying user selection criteria 216 may increase the likelihood of a car advertisement being selected for download and display to the particular user.

If the result of query functionality 504 is negative (“NO”), the flow proceeds to end functionality 506 wherein the process flow terminates. In at least some embodiments, prior downloaded and viewed ad 212 is caused to be deleted from memory 400.

If the result of query functionality 504 is positive (“YES”), the flow proceeds to view ad functionality 508 wherein ad 212 is downloaded and displayed to user 108. In at least some embodiments, ad campaign 210 comprising ad 212 is downloaded to user 108. After user 108 completes viewing ad 212, the flow proceeds to user rank ad query functionality 510.

During execution of user rank ad query functionality 510, processor 200 determines whether a user vote 314 is received from user system 110. If the result of query functionality 510 is negative (“NO”), the flow proceeds to return to query functionality 504 and content delivery system 106 determines whether user 108 matches another ad 212 and the process flow continues as described above.

In at least some embodiments, if the result of query functionality 510 is negative (“NO”), the process flow proceeds to end functionality 506 and no more ads are downloaded and/or displayed to user 108.

If the result of query functionality 510 is positive (“YES”), the flow proceeds to update rank functionality 512 wherein user vote set 304 is updated to include the received user vote. The process flow then proceeds to return to query functionality 504 and the process flow continues as described above.

In at least some embodiments, execution of update rank functionality 512 causes processor 200 of content delivery system 106 to transmit one or more pieces of user information to content generation system 104. In at least some embodiments, user information transmitted comprises positive or negative vote information corresponding to an ad 212 transmitted to the delivery system by the content generating system. In at least some other embodiments, user information transmitted comprises user demographic and bibliographic information, e.g., Internet Protocol (IP) address of user system 110, location of user 108, user interests, software in which ad viewer 308 is executing, type of device of user system 110, etc.

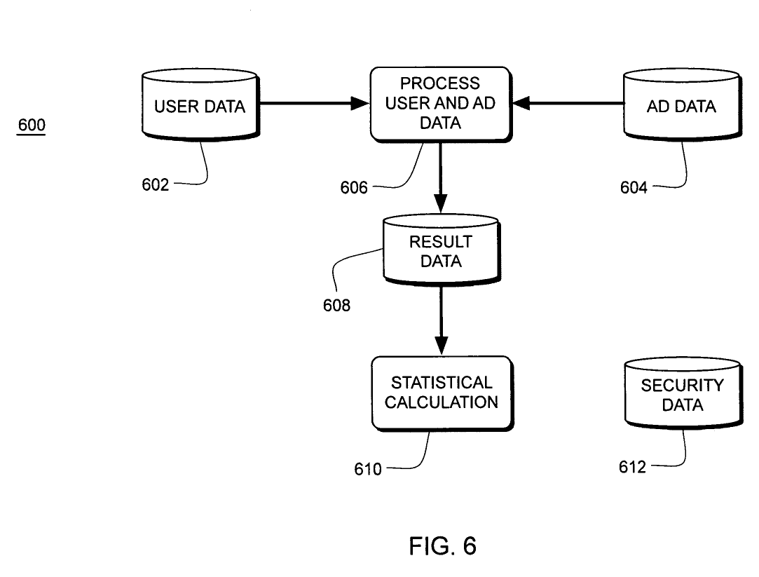

FIG. 6 depicts a high-level functional block diagram of at least a data storage portion 600 of CDEI 316 according to an embodiment. Data storage portion 600 comprises a user data storage 602 (also referred to as user data) for storing user-related data such as user name and demographic information. In at least one embodiment, user data storage 602 also stores information related to the platform, e.g., computer system, settop box, etc., by which the user accesses CDEI 316. In at least some embodiments, user data storage 602 is a database.

Data storage portion 600 also comprises an advertisement data storage 604 (also referred to as ad data storage or ad data) for storing advertisement-related data such as advertisements (e.g., ad 212 or ad campaign 210), ad viewing reward 214, user selection criteria 216, user vote set 304, reward catalog 306, etc. In at least one embodiment, ad data storage 604 also stores user vote 314. In at least some embodiments, ad data storage 604 is a database.

Data storage portion 600 also comprises process functionality 606, e.g., a set of instructions arranged for execution by processor 200 (FIG. 3), which when executed cause the processor to process user data retrieved from user data 602 and ad data retrieved from ad data 604 as described above with respect to one or more embodiments. For example in at least one embodiment, process functionality 606 determines the rank of an advertisement based on user votes. In at least another embodiment, process functionality 606 determines advertisement ranking on a per user basis or across all users or with respect to a particular subset of users.

Data storage portion 600 also comprises result data storage 608 (also referred to as result data) for storing the results of process functionality 606. In at least some embodiments, result data 608 is a database.

Data storage portion 600 also comprises statistical calculation functionality 610, e.g., a set of instructions arranged for execution by processor 200 (FIG. 3), which when executed cause the processor to perform statistical calculations with respect to the result data 608. In at least some embodiments, process functionality and statistical calculation functionality 610 may be combined into a single functionality, i.e., a single set of executable instructions.

Data storage portion 600 also comprises security data storage 612 (also referred to as security data) for storing security-related information. In at least some embodiments, security data 612 stores information related to security incidents which may have occurred with respect to users and/or advertisers using CDEI 316. In at least some embodiments, security data 612 stores password information.

In at least some embodiments, two or more of user data 602, ad data 604, result data 608, or security data 612 may comprise a part of a single data store.

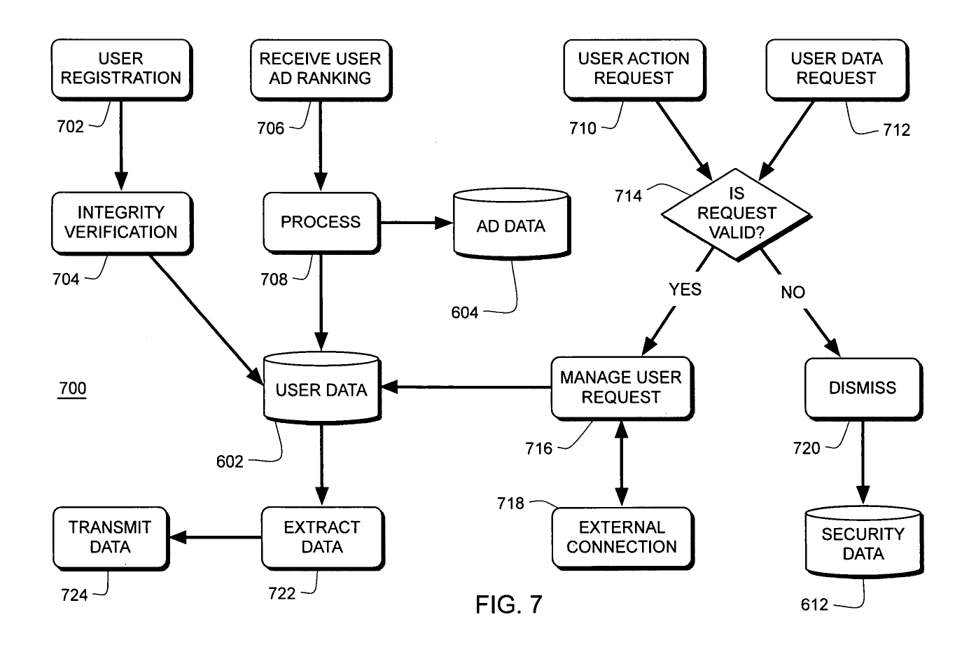

FIG. 7 depicts a high-level functional process flow diagram of at least a user interaction portion 700 of CDEI 316 according to an embodiment. User interaction portion 700 comprises one or more modules of functionality (indicated by rounded rectangles) which each comprise one or more sets of instructions for execution by processor 200 (FIG. 3).

User interaction portion 700 comprises a user registration module 702 for registering a user with CDEI 316, e.g., receiving a user name or identifier (ID) and/or password. In at least some embodiments, user registration module 702 receives demographic information related to the user.

The process flow then proceeds to integrity verification module 704 wherein the functionality verifies the integrity of received user information from user registration module 702 execution. Integrity verification module 704 then stores verified information in user data 602.

User interaction portion 700 also comprises a receive user ad ranking module 706 for receiving a user vote (e.g., user vote 314 (FIG. 3)) related to an advertisement (e.g., ad 212 (FIG. 3)). In at least some embodiments, user interaction portion 700 also receives user platform-related information and user-related information. The process flow then proceeds to process module 708 wherein information related to the received user vote is processed and stored, as appropriate, in user data 602 and/or ad data 604.

User interaction portion 700 also comprises a user action request module 710 for receiving a requested action of a user, e.g., via a web browser or other client interface. User action request module 710 receives one or more requests from a user for an action requested to be performed by CDEI 316 (FIG. 3) as described above such as modifying user registration information.

Similarly, user interaction portion 700 also comprises a user data request module 712 for receiving a data request of a user. In at least some embodiments, user action request module 710 and user data request module 712 may be combined into a single module. User data request module 712 receives one or more data requests from a user for data.

Subsequent to execution of either module 710 or 712, the process flow proceeds to a request validation module 714. Execution of request validation module 714 determines whether the received user request, i.e., either action or data-related, is valid.

If the result of request validation module 714 is positive (“YES”), the process flow proceeds to manage user request module 716 wherein the requested data and/or action is obtained/performed by CDEI 316 (FIG. 3) with respect to either user data 602 or via an external connection module 718, as appropriate. In at least some embodiments, external connection module 718 may comprise an interface to a system separate from CDEI 316 (FIG. 3).

If the result of request validation module 714 is negative (“NO”), the process flow proceeds to a dismiss module 720 wherein the request is dismissed, e.g., either via non-acknowledgement of the request or via generation of an error or other indication for presentation to the user. In at least some embodiments, information related to the invalid request is stored in security data 612.

Responsive to execution of one or more of user registration module 702, user ad ranking module 706, user action request module 710, or user data request module 712, an extract data module 722 is executed for obtaining/modifying data of user data 602, as appropriate. The flow proceeds to a transmit data module 724 wherein the extracted data is transmitted to the user, e.g., for display to the user.

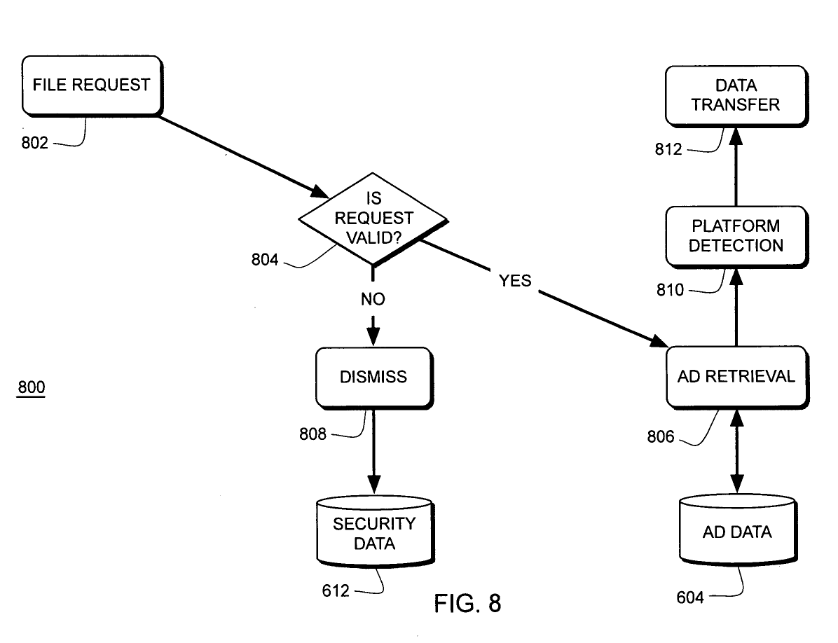

FIG. 8 depicts a high-level functional process flow diagram of at least an advertisement transfer portion 800 of CDEI 316 according to an embodiment. Transfer portion 800 comprises one or more modules of functionality (indicated by rounded rectangles) which each comprise one or more sets of instructions for execution by processor 200 (FIG. 3).

Transfer portion 800 comprises a file request module 802 for receiving a request for at least one of an ad campaign 210 and/or an ad 212. In at least some embodiments, file request module 802 receives file requests from users, advertisers, or operators of CDEI 316 (FIG. 3). The flow proceeds to a request validation module 804. Execution of request validation module 804 determines whether the received file request is valid.

If the result of request validation module 804 is positive (“YES”), the process flow proceeds to ad retrieval module 806 wherein the requested file is obtained/performed by CDEI 316 (FIG. 3) with respect to ad data 604.

If the result of request validation module 804 is negative (“NO”), the process flow proceeds to a dismiss module 808, similar to dismiss module 714 described above, wherein the request is dismissed, e.g., either via non-acknowledgement of the request or via generation of an error or other indication for presentation to the user. In at least some embodiments, information related to the invalid request is stored in security data 612.

Returning to ad retrieval 806, subsequent to or during retrieval of ad from ad data 604, the flow proceeds to a platform detection module 810 wherein the platform, e.g., computer system, settop box, etc., used by the user is determined based on supplied user information. In at least some embodiments, the retrieved ad is modified based on the particular platform detected. The flow then proceeds to a data transfer module 812 wherein the retrieved file is transmitted to the requester, e.g., to a user via network 102.

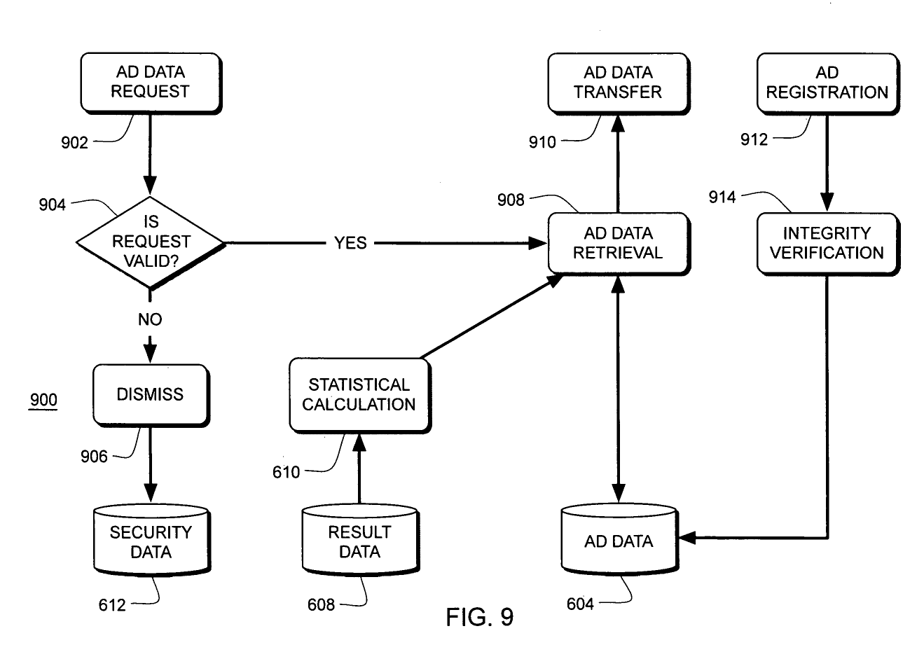

FIG. 9 depicts a high-level functional process flow diagram of at least an advertiser interaction portion 900 of CDEI 316 according to an embodiment. Interaction portion 900 comprises one or more modules of functionality (indicated by rounded rectangles) which each comprise one or more sets of instructions for execution by processor 200 (FIG. 3).

Interaction portion 900 comprises an ad data request module 902 for receiving a request for data related to an advertisement, e.g., from an advertiser. The flow proceeds to a request validation module 904. Execution of request validation module 904 determines whether the received ad data request is valid.

If the result of request validation module 904 is negative (“NO”), the process flow proceeds to a dismiss module 906, similar to dismiss module 714 described above, wherein the request is dismissed, e.g., either via non-acknowledgement of the request or via generation of an error or other indication for presentation to the user. In at least some embodiments, information related to the invalid request is stored in security data 612.

If the result of request validation module 904 is positive (“YES”), the process flow proceeds to ad retrieval module 906 wherein the requested ad data is retrieved from ad data 604. In at least some embodiments, ad data retrieval module 906 obtains ad-related data resulting from statistical calculation module 610. In at least some embodiments, ad data retrieval module 906 obtains the ad-related data directly from result data 608.

After the ad data is obtained, the flow proceeds to ad data transfer 910 wherein the obtained ad data is transmitted to the requester, e.g., an advertiser at content generation system 104 (FIG. 1).

Interaction portion 900 also comprises an ad registration module 912 for receiving registration information related to an advertisement and/or ad campaign 210 (FIG. 2). In at least some embodiments, an advertiser at content generation system 104 registers with content delivery system 106 similar to user registration described in connection with FIG. 7 above. In at least some embodiments, an advertiser registers an advertisement 212 or an ad campaign 210 with content delivery system 106 by providing information related to the advertisement and/or the ad campaign. The flow then proceeds to integrity verification module 914 wherein the registration information is verified and stored in ad data 604.

It will be readily seen by one of ordinary skill in the art that the disclosed embodiments fulfill one or more of the advantages set forth above. After reading the foregoing specification, one of ordinary skill will be able to affect various changes, substitutions of equivalents and various other embodiments as broadly disclosed herein. It is therefore intended that the protection granted hereon be limited only by the definition contained in the appended claims and equivalents thereof.

What is claimed is:

1. A system for rewarding online viewing of advertisements, comprising:
a processor; and
a memory comprising a set of executable instructions which, when executed by the processor, cause the processor to receive a user profile comprising demographic user information; to receive an advertising campaign comprising at least one advertisement, at least one reward amount identifier, and at least one user selection criteria; to transmit at least one advertisement to a user based on a comparison of the at least one user selection criteria and the user profile; and receive a user vote based on the at least one advertisement.

2. The system as claimed in claim 1, wherein the set of instructions further comprise instructions to cause the execution of the instructions after a predetermined amount of time during which the system receives no user input.

3. The system as claimed in claim 1, wherein the set of instructions further comprise instructions to cause the processor to receive a modification to the user profile.

4. The system as claimed in claim 1, wherein the set of instructions further comprise instructions to cause the processor to receive modifications to the received advertising campaign.

5. The system as claimed in claim 1, wherein the set of instructions further comprise instructions to cause the processor to transmit the user vote to a content generation system.

6. The system as claimed in claim 1, wherein the set of instructions further comprise instructions to cause the processor to allocate an amount equal to the reward amount identifier to the user responsive to receipt of the user vote.

7. The system as claimed in claim 6, wherein the set of instructions further comprise instructions to cause the processor to allocate an amount equal to the reward amount identifier only after determining that the user viewed and voted on an advertisement.

8. The system as claimed in claim 1, wherein the set of instructions further comprise instructions to cause the processor to display a reward catalog to the user.

9. A method of rewarding online viewing of advertisements, comprising:
receiving a user profile comprising demographic user information;
receiving an advertising campaign comprising:
at least one advertisement;
at least one reward amount identifier; and
at least one user selection criteria;
transmitting at least one advertisement to a user based on a comparison of the at least one user selection criteria and the user profile; and
receiving a user vote based on the at least one advertisement.

10. The method as claimed in claim 9, wherein the transmitting at least one advertisement to a user occurs after expiration of a predetermined amount of time in which no user input is received.

11. The method as claimed in claim 9, further comprising maintaining a count of the received user vote.

12. The method as claimed in claim 9, further comprising transmitting information related to the received user vote to an advertiser.

13. The method as claimed in claim 12, wherein the information transmitted comprises the received user vote and at least a portion of the user profile.

14. The method as claimed in claim 9, further comprising adjusting a user reward balance by an amount in relation to the at least one reward amount identifier responsive to the received user vote.

15. The method as claimed in claim 14, further comprising adjusting the user reward balance by an amount in relation to a value of a reward item in a reward catalog selected for redemption by the user based on the user reward balance exceeding the reward item value.

16. A memory or a computer-readable medium storing instructions which, when executed by a processor, cause the processor to perform the method of claim 9.
